(19) United States
(12) Patent Application Publication
(10) Pub. No.: US 2024/0330942 A1
(43) Pub. Date: Oct. 3, 2024

(54) METHOD AND DEVICE FOR PROVIDING CONSUMER SENTIMENT ANALYSIS

(71) Applicant: Wells Fargo Bank, N. A., San Francisco, CA (US)

(72) Inventors: Michael Paul Bortis, Tustin, CA (US); Austin Lee Grelle, Riverside, IL (US); Manesh Saini, New York, NY (US); Laura Kaye Woten, Stuart, IA (US)

(21) Appl. No.: 18/192,223

(22) Filed: Mar. 29, 2023

(51) Int. Cl. G06Q 30/015; G06Q 30/0601; G06V 40/16; G10L 17/00

(52) U.S. Cl. CPC G06Q 30/015; G06Q 30/0631; G06V 40/172; G06V 40/174; G10L 17/00

(57) ABSTRACT

Systems and methods may generally be used for detecting presence of a customer at a geographic location associated with an institution. Sentiment of the customer can be determined prior to interaction of the customer with the institution based on analysis of a characteristic of the customer. A recommendation can be generated for interacting with the customer based on the sentiment.

### BACKGROUND

To remain competitive in the modern commercial environment, businesses should remain alert to changes in customer sentiment. For example, customers may interact with a business differently depending on the type of day they are having, or on varying customer characteristics, whether individually or as a group. Businesses that address customer needs according to current customer sentiment may have a competitive advantage.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a system in which example embodiments may be performed.

FIG. 2 illustrates a display for displaying information relevant to sentiment analysis in accordance with some embodiments.

FIG. 3 illustrates machine learning engine for training and execution in accordance with some embodiments.

FIG. 4 illustrates a flowchart showing a technique for analyzing customer sentiment in accordance with some embodiments.

FIG. 5 illustrates generally an example of a block diagram of a machine upon which any one or more of the techniques discussed herein may perform in accordance with some embodiments.

### DETAILED DESCRIPTION

Systems and techniques described herein may be used to determine customer sentiment as customers enter a retail branch of a business. Certain needs of the customer can be predicted based on facial recognition or other user input indicative of sentiment. Sentiment can be used separately or in combination with compliance data or other data available to business employees at the branch. Retail branches, including banking branches may interact with surly or upset customers in a way that exacerbates customer issues. These failures to properly interact can cause problems for a retail location, including poor customer perception and loss of customers. Other customers may be subject to changing compliance issues that could have been detected or predicted by the bank, and failure to predict such issues can result in lost sales opportunities or even in sanctions being taken against customers.

These and other concerns are addressed using systems and techniques of various embodiments that perform a sentiment analysis on a customer (with opt in/customer preferences) to determine a recommendation for a retailer, bank, etc. on methods and styles of interacting with the customer. Customers can opt in for such analysis when setting up an account or in another similar configuration phase.

Recommendations for interaction may be provided on a banker/retailer dashboard, which may be customized to the customer. The sentiment analysis can provide different types of outputs or suggestions. For example, the sentiment analysis may provide a preferred method of interaction (e.g., a customer may prefer to meet privately with a banker rather than speak in less private surroundings with a teller). The sentiment analysis can predict or detect a customer style or mood (e.g., jovial, subdued, etc.) either as a general customer style or on a temporary or case-by-case basis. The sentiment analysis can provide a suggestion of products to offer (e.g., customer has indicated on weekdays they are in a hurry, but Saturdays they would like to hear more about available products), or the like. When the customer has indicated a willingness to hear suggestions about additional products, a banker or specialist can be informed at the institution branch or location and the customer can be approached by the banker or specialist, whether through a teller or directly. Products can include investment products, savings plan products, real estate discussions, retirement, etc.

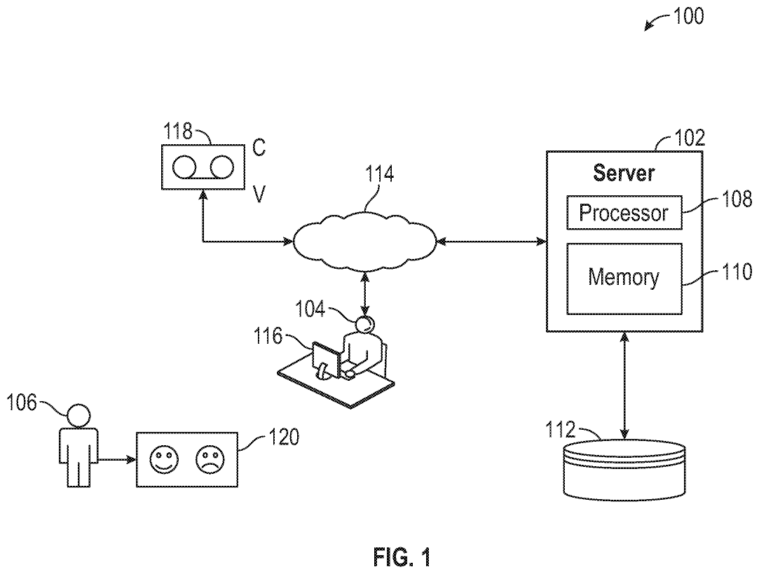

FIG. 1 illustrates a system 100 in which example embodiments may be implemented. The system 100 includes a server 102, which may be used to generate recommendations to an institution 104 (or agent such as a bank teller, retail clerk, etc.) for interacting with customer 106. The server 102 may include a processor 108 and memory 110 and may be in communication with or include a database 112. The server 102 may communicate, for example, via a network 114 (e.g., the Internet), with the institution 104 (or a computing device 116 provided to the institution 104 agent).

The server 102 can also communicate with a device 118 configured to detect facial expressions or language. The device 118 can comprise a tape recorder, digital recorder, camera (or other image capturing circuitry), etc. and can be incorporated in the computing device 116 or separate from the computing device 116. The device 118 can detect presence of the customer 106 at a geographic location associated with the institution 104. Voice and voice stress levels can be detected using the device 118 and based on natural language processing (NLP) in some examples.

The server 102 may be operated by a retail chain (either banking or other retail) or by a home office or regional office of such a retail chain. The processor 108 can use information transmitted from, e.g., the device 118, the computing device 116 or directly as spoken by the customer 106 or institution 104 agent or as captured on video camera or other associated camera, to detect sentiment of the customer 106 upon entering a branch of the institution 104.

The processor 108 can determine customer sentiment of the customer 106 prior to interaction of the customer 106 with the institution 104. This determination can be based on analysis of a characteristic of the customer. The characteristic can be physical, for example facial expression, gait, or pace, which can be used to detect whether the customer 106 is happy, ill, distracted, etc. The characteristic can determine identity of the customer 106 when, for example, the customer 106 has provided permission for facial recognition, or has uploaded a photograph, etc. to the institution 104 or server 102. The characteristic can be directly indicated by the customer 106 using a device 120. For example, the device 120 can include a push button or other electrical system wherein the customer can indicate mood or sentiment. The mood characteristic or other characteristic can be determined based on analysis of the natural language generated during a presently occurring interaction, or on analysis of a set of previous interactions whether with the customer 106 or similar customers.

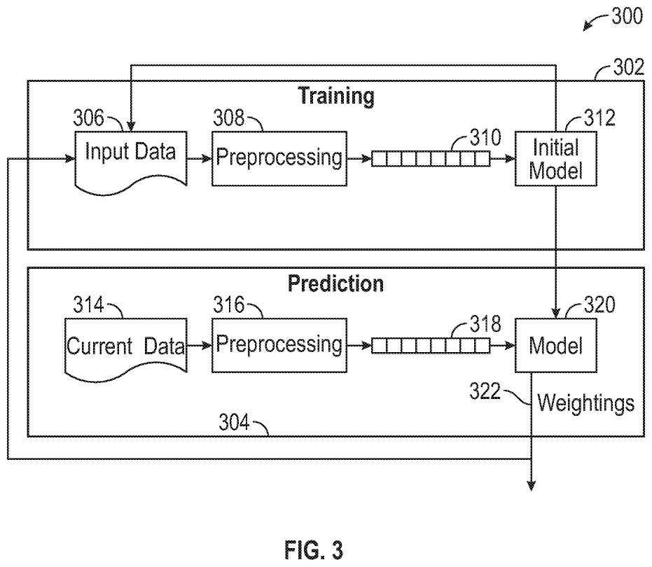

The database 112 or the server 102 may store a model (e.g., a machine learning trained model described later herein with respect to FIG. 3); laws or regulations that might apply to a branch, region, or bank; regulatory data; or regulatory databases that link particular customers to regulations that apply to those customers, etc. The regulations can include local laws, federal laws, military laws, etc. In some examples local laws can regulate interactions in one location (e.g., bank branch, retail location) that are not regulated in another location. For example, a protected group in one location or jurisdiction may not be a protected group in another location or jurisdiction. The database 112 can also store any notes or texts input by the institution 104 or recordings (video or audio, etc.) of the customer 106, device 118, or computing device 116 or device 120. The server 102 may retrieve the model, recordings, or other data from the database 112 to use in providing recommendations for actions to be taken with respect to the customer 106.

The device 118 or the computing device 116 can detect language (and voice or vocal characteristics indicating stress level or mood) used by the customer 106 or agent of the institution 104 and provide the language as an input to NLP algorithms as described with respect to FIG. 3. In examples in which the interaction is online or virtual, language detection can be done based on emails or texts or telephone calls/recordings of the customer 106 or by notes entered in the computing device 116 by the agent of the institution 104. The NLP can also be adapted based on customer stress level. For example, when if a customer 106 is using language indicative of a high stress level, risk reduction actions can be taken with respect to the customer 106.

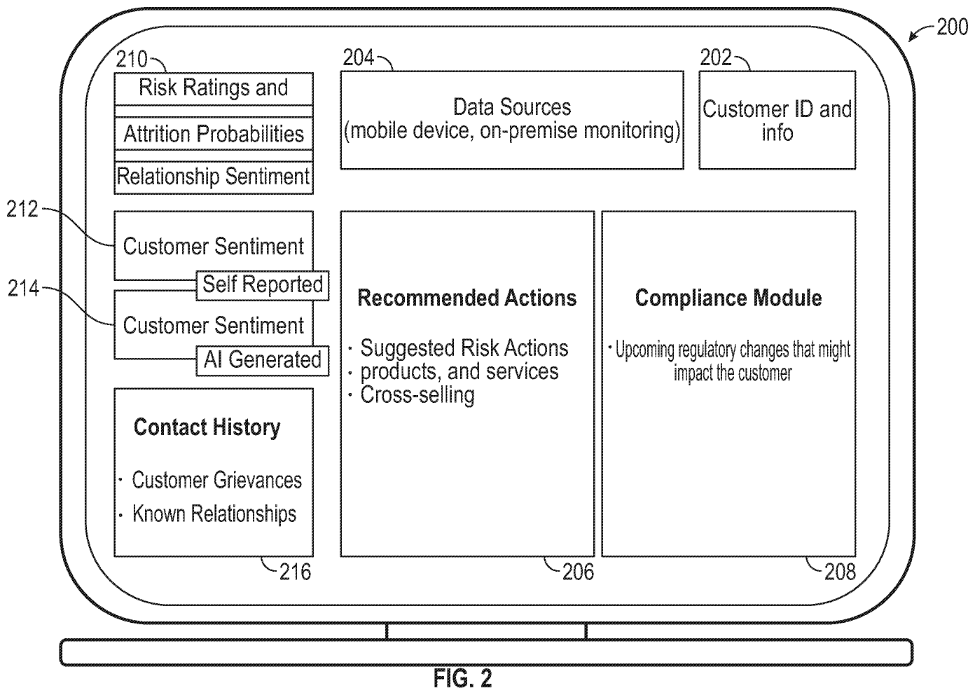

The processor 108 can generate a recommendation for interacting with the customer 106 or other customers during subsequent interactions with the institution. For example, by detecting a mood or sentiment of the customer 106, staff within a bank or other retail branch can modify reactions to the customer, provide additional services, etc. Recommendations can include recommendations to provide additional personnel for dealing with a customer who appears to be undergoing stress or other temperamental concerns. Recommendations can include recommendations to provide more personalized service (in the case of a high value customer or a customer having language barriers, disabilities, etc. When sentiment is neutral, Recommendations can include recommendations to further gauge customer sentiment in a limited manner. Using the model described with respect to FIG. 3, the processor 108 can determine whether the customer is upset, and a possible or likely negative interaction can be detected. Displays according to FIG. 2 can be provided as described below.

FIG. 2 illustrates a display 200 for displaying information relevant to sentiment analysis in accordance with some embodiments. The display 200 can be populated with information by the processor 108, which can access information in the database 112. Sentiment analysis indicated in the display 200 may be used to determine a recommendation for a customer 106 interaction with a retail branch or employees thereof. In examples, the retail branch can be a banking branch, although embodiments are not limited thereto. The display 200 can be provided on the computing device 116 (FIG. 1), simultaneously at a remote location for remote monitoring, or simultaneously at another location within a retail branch, bank branch, etc.

As mentioned with respect to FIG. 1, systems and methods according to embodiments can include detection of customer 106 presence at a geographic location associated with the retail location, bank branch, etc. The customer 106 can be further identified, e.g., using a QR code, beacon, facial recognition, or based on a radio frequency identifier (RFID) chip on the customer 106 debit/credit card, etc. to generate customer identification information 202 on the display 200. The identification information 202 can include a customer 106 profile, including indications regarding income, demographic data, bank balance information, etc. Information 202 can include purpose of the current visit, a timer indicating how long the customer 106 has been waiting, and other information relevant to or specific to a current visit. Information 202 can further include profile information provided by the customer 106 himself or herself. For example, the customer 106 may previously have indicated (online, by mail, email etc.) that the customer has poor hearing or eyesight, etc. and therefore prefers large print brochures, private conversations in a quiet area, etc.

The display 200 can include an indicator 204 of the source or sources of data being provided about the customer 106. For example, referring to FIG. 1, data sources can include a customer 106 mobile device; device 118, which may include video, audio and photographic capabilities; device 120, etc.

Referring again to FIG. 2, the display 200 can provide recommended actions 206 for next-subsequent or any future interactions with the customer 106. Example recommended actions can include opportunities for cross-sales. For example, based on both customer sentiment and profile information generated upon the customer 106 entering a retail location, a high-income customer 106 may be presented with opportunities for further investments. A customer 106 with a newborn may be presented with opportunities for a college saving fund, etc. In cases of customer agitation, recommended actions 206 can encompass de-escalation steps to reduce risk to the branch location and other customers.

The display 200 can include a compliance area 208 that provides information regarding federal, international or local regulations that may be relevant to the customer 106 either at the current visit or more generally. Upcoming or recent regulatory changes may be flagged and/or provided that may be of particular impact on the customer 106 based on the customer 106 profile. For example, a customer 106 who runs an import/export business or other business dealing with foreign countries may be provided with updated information regarding certain restrictions with different countries. This information can allow a retail branch (particularly a bank branch) to be more proactive with respect to customers. For customers with protected classes of needs can have alternate procedures or presentation of material based on their needs with the information displayed in compliance area 208. For example, a customer who is color blind has a need covered by certain applicable regulations and policies which can be presented to the institution representative 104. Another example would be a customer where they are an active service member, where certain procedures such as repossession of vehicles have additional compliance related tasks. A bank branch can thereby provide an enhanced, value-added service to its customers by access to additional or specialized knowledge, thus enhancing the reputation of the bank branch with the customer 106 and with similar customers.

The display 200 can include a field 210 for indicating the risk that the customer 106 may terminate his or her relationship with the bank or other institution. This risk can be based on relationship sentiment indicators learned in artificial intelligence (AI) algorithms, through analysis of any communications the customer 106 has had with the bank or based on demographic information of the customer 106. For example, customer 106 just leaving college may be about to leave a bank located on campus, or a customer nearing retirement may be about to terminate relationships in a particular city on anticipation of moving to a retirement community. A customer 106 who has had one or more unfavorable interactions with a bank institution will be more likely to terminate a relationship with that institution. Field 210 serves as a “quick glance” indicator of the overall sentiment, with a coupling to recommended actions 206 and compliance area 208 based on the proportion and directionality of the customer's sentiment.

The display 200 can include a field 212 indicating self-reported customer sentiment. The display 200 can also include a field 214 indicating customer sentiment as analyzed according to AI or other algorithms described later below. Field 212 may or may not match field 214. A mismatch between field 212 and field 214 may in turn indicate that remedial communications should be made with the customer 106 to determine ways in which to improve the relationship with the customer 106. The display 200 can also include contact history information 216, which can be retrieved from the database 112 (FIG. 1). If previous grievances are displayed, the institution may address this in a current interaction or next subsequent interaction.

FIG. 3 illustrates a machine learning engine 300 for training and execution in accordance with some embodiments. The machine learning engine 300 may be deployed to execute at provider server 102, for example by the processor 108 (FIG. 1). A system may perform NLP using the machine learning engine 300 and the system may monitor user sentiment using the machine learning engine 300.

Machine learning engine 300 uses a training engine 302 and a prediction engine 304. Training engine 302 uses input data 306, for example after undergoing preprocessing component 308, to determine one or more features 310. The one or more features 210 may be used to generate an initial model 312, which may be updated iteratively or with future labeled or unlabeled data (e.g., during reinforcement learning). Comparison can be done to detect whether sentiment was correctly determined through feedback when a customer interaction is determined to have been successful or unsuccessful, and/or based on historical interactions of customers with similar profiles.

The input data 306 may include natural language of the customer 106 or of an agent of the institution 104 during interaction with the customer 106. In the prediction engine 304, current data 314 may be input to preprocessing component 316. In some examples, preprocessing component 316 and preprocessing component 308 are the same. The prediction/reaction engine 304 produces feature vector 318 from the preprocessed current data, which is input into the model 320 to generate one or more criteria weightings 322. The criteria weightings 322 may be used to output a prediction, as discussed further below.

The training engine 302 may operate in an offline manner to train the model 320 (e.g., on a server). The prediction/reaction engine 304 may be designed to operate in an online manner (e.g., in real-time). In some examples, the model 320 may be periodically updated via additional training (e.g., via updated input data 306 or based on data output in the weightings 322) or based on identified future data, such as by using reinforcement learning to personalize a general model (e.g., the initial model 312) to a particular user. In some examples, the training engine 302 may use a trend analysis over time, for example with a user selected or a model identified range.

The initial model 312 may be updated using further input data 306 until a satisfactory model 320 is generated. The model 320 generation may be stopped according to a specified criteria (e.g., after sufficient input data is used, such as 1,000, 10,000, 100,000 data points, etc.) or when data converges (e.g., similar inputs produce similar outputs).

The specific machine learning algorithm used for the training engine 302 may be selected from among many different potential supervised or unsupervised machine learning algorithms, including commercial algorithms for detecting and interpreting natural language or for performing analysis of sentiment based on facial expression or other physical characteristics of a customer. Examples of supervised learning algorithms include artificial neural networks, Bayesian networks, instance-based learning, support vector machines, decision trees (e.g., Iterative Dichotomiser 3, C9.5, Classification and Regression Tree (CART), Chi-squared Automatic Interaction Detector (CHAID), and the like), random forests, linear classifiers, quadratic classifiers, k-nearest neighbor, linear regression, logistic regression, and hidden Markov models. Examples of unsupervised learning algorithms include expectation-maximization algorithms, vector quantization, and information bottleneck method. Unsupervised models may not have a training engine 302. In an example embodiment, a regression model is used and the model 320 is a vector of coefficients corresponding to a learned importance for each of the features in the vector of features 310, 318. A reinforcement learning model may use Q-Learning, a deep Q network, a Monte Carlo technique including policy evaluation and policy improvement, a State-Action-Reward-State-Action (SARSA), a Deep Deterministic Policy Gradient (DDPG), or the like.

Once trained, the model 320 may be able to determine a customer's sentiment or emotional state. By detecting sentiment, the processor 108 can predict future actions of the customer 106 and can provide recommendations for servicing or dealing with that customer, either in real time or in subsequent interactions.

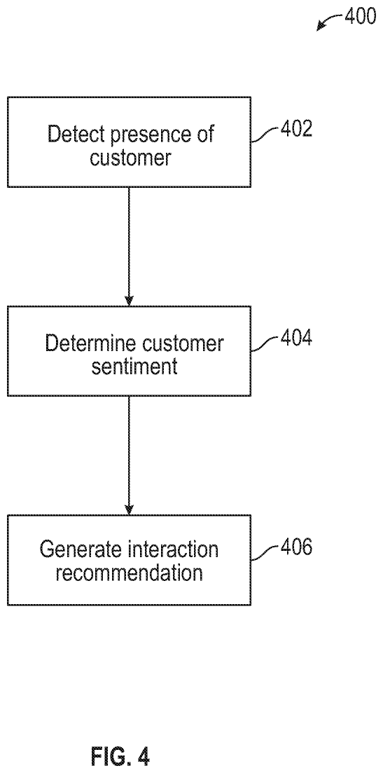

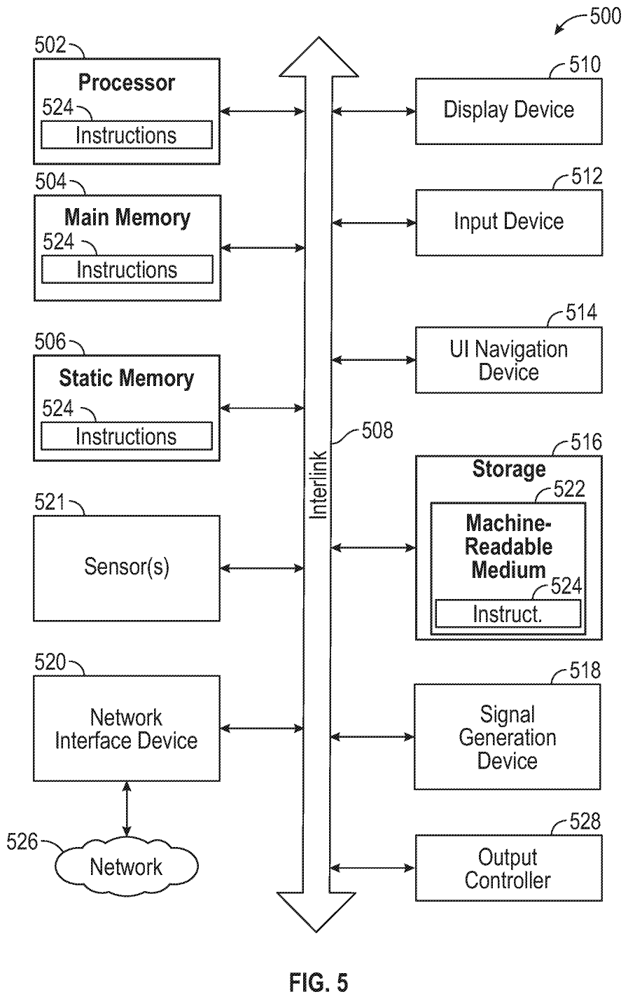

FIG. 4 illustrates a flowchart showing a method 400 for managing customer interactions with an institution 104 in accordance with some embodiments. In an example, operations of the method 400 may be performed by processing circuitry, for example processor 108 (FIG. 1). The method 400 may be performed by processing circuitry of a device (or one or more hardware or software components thereof), such as those illustrated and described with reference to FIG. 5.

The method 400 includes an operation 402 to detecting presence of a customer 106 at a geographic location associated with an institution 104. The detection can be based on detecting a QR code, detecting an RFID tag of a customer 106 credit card, etc. Once detected in the geographical location, the customer 106 can be identified based on facial recognition.

The method 400 includes an operation 404 to determine customer sentiment of the customer 106 prior to interaction of the customer 106 with the institution 104 based on analysis of a characteristic of the customer 106. The characteristic can include facial expressions detected by device 118, direct customer input provided at device 120, detecting of gait or pace of the customer 106 based on video data provide by the device 118, etc.

The method 400 includes an operation 406 to generate a recommendation for interacting with the customer 106 based on the sentiment determined at operation 404. Needs can be predicted, and recommendations can be provided based on regulatory data, for example laws relating to the customer 106 business or demographic group, or on updates to such regulations.

FIG. 5 illustrates generally an example of a block diagram of a machine 500 upon which any one or more of the techniques (e.g., methodologies) discussed herein may perform in accordance with some embodiments. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the execution units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, alphanumeric input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 that is non-transitory on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), a legacy telephone network, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software.

The following, non-limiting examples, detail certain aspects of the present subject matter to solve the challenges and provide the benefits discussed herein, among others.

Example 1 is a method comprising: detecting presence of a customer at a geographic location associated with an institution; determining a customer sentiment of the customer, at the geographic location, prior to interaction of the customer with the institution based on analysis of a characteristic of the customer; and generating, based on the determining, a recommendation for interacting with the customer at the geographic location, during an interaction with the institution.

In Example 2, the subject matter of Example 1 can optionally include identifying the customer based on facial recognition.

In Example 3, the subject matter of Example 2 can optionally include wherein the characteristic includes on at least one of a facial expression, a gait, or a pace of the customer.

In Example 4, the subject matter of Example 2 can optionally include wherein the customer sentiment is detected based on direct input by the customer/

In Example 5, the subject matter of any of Examples 1-4 can optionally include identifying the customer based on voice.

In Example 6, the subject matter of Example 5 can optionally include wherein the characteristic includes a vocal characteristic indicative of a mood of the customer.

In Example 7, the subject matter of any of Examples 1-6 can optionally include predicting a customer need based upon regulatory data or a change in regulatory data.

In Example 8, the subject matter of any of Examples 1-7 can optionally include wherein the recommendation includes a sales recommendation.

In Example 9, the subject matter of any of Examples 1-8 can optionally include wherein generating the recommendation includes providing data indicators to a display of an employee of the institution.

In Example 10, the subject matter of any of Examples 1-9 can optionally include wherein detecting customer sentiment includes implementing an artificial intelligence (AI) algorithm.

In Example 11, the subject matter of Example 10 can optionally include wherein training of the AI algorithm is based on historical interactions with the customer or similar customers.

In Example 12, the subject matter of any of Examples 1-11 can optionally include wherein the geographic location comprises a retail location.

In Example 13, the subject matter of any of Examples 1-12 can optionally include providing recommendations for subsequent or future interactions.

In Example 14, the subject matter of any of Examples 1-13 can optionally include providing recommendations for interacting with other customers similar to the customer.

Example 15 is a system comprising means for performing any of Examples 1-14.

Example 16 is a non-transitory computer-readable medium including instructions that, when executed on a processor, cause the processor to perform operations including any of Examples 1-14.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

What is claimed is:

1. A method comprising:
detecting presence of a customer at a geographic location associated with an institution;
determining a customer sentiment of the customer, at the geographic location, prior to interaction of the customer with the institution based on analysis of a characteristic of the customer; and
generating, based on the determining, a recommendation for interacting with the customer at the geographic location, during an interaction with the institution.

2. The method of claim 1, comprising identifying the customer based on facial recognition.

3. The method of claim 2, wherein the characteristic includes on at least one of a facial expression, a gait, or a pace of the customer.

4. The method of claim 2, wherein the customer sentiment is detected based on direct input by the customer.

5. The method of claim 1, comprising identifying the customer based on voice.

6. The method of claim 5, wherein the characteristic includes a vocal characteristic indicative of a mood of the customer.

7. The method of claim 1, comprising:
predicting a customer need based upon regulatory data or a change in regulatory data.

8. The method of claim 1, wherein the recommendation includes a sales recommendation.

9. The method of claim 1, wherein generating the recommendation includes providing data indicators to a display of an employee of the institution.

10. The method of claim 1, wherein detecting customer sentiment includes implementing an artificial intelligence (AI) algorithm.

11. The method of claim 10, wherein training of the AI algorithm is based on historical interactions with the customer or similar customers.

12. The method of claim 1, wherein the geographic location comprises a retail location.

13. The method of claim 1, further comprising providing recommendations for subsequent or future interactions.

14. The method of claim 1, comprising providing recommendations for interacting with other customers similar to the customer.

15. A system for detecting customer sentiment, the system comprising:
a device configured to detect presence of a customer at a geographic location associated with an institution;
a processor coupled to the device and configured to determine customer sentiment of the customer prior to interaction of the customer with the institution based on an analysis of a characteristic of the customer; and
a display coupled to the processor and configured to provide recommendations for interacting with the customer during an interaction with the institution.

16. The system of claim 15, wherein the device includes image capturing circuitry and wherein the customer is identified based on facial recognition.

17. The system of claim 16, wherein the characteristic includes at least one of facial expression, pace, or gait.

18. The system of claim 15, further including memory for storing customer history and regulatory data, and wherein the processor is configured to generate the recommendation further based on at least one of the customer history and the regulatory data.

19. A non-transitory computer-readable medium including instructions that, when executed on a processor, cause the processor to perform operations including:
detecting presence of a customer at a geographic location associated with an institution;
determining customer sentiment of the customer prior to interaction of the customer with the institution based on analysis of a characteristic of the customer; and
generating, based on the determining, a recommendation for interacting with the customer or similar other customers during an interaction with the institution.

20. The non-transitory computer-readable medium of claim 19, wherein the operations further include identifying the customer based on facial recognition, and wherein determining customer sentiment is based on customer history of the identified customer.

21. The non-transitory computer-readable medium of claim 19, wherein the operations include receiving video or photographic information of the customer and wherein the characteristic includes at least one of a facial expression, a gait, or a pace of the customer provided in the video or photographic information.
